(19) United States
(12) Patent Application Publication
(10) Pub. No.: US 2011/0055260 A1
(43) Pub. Date: Mar. 3, 2011

(54) SYSTEMS AND METHODS FOR DELIVERING A WEB PAGE TO A USER IN RESPONSE TO A PAGE REQUEST

(75) Inventor: Adam GOLDBAND, Antioch, CA (US)

(73) Assignee: CBS INTERACTIVE, INC., Country of New Castle, DE (US)

(21) Appl. No.: 12/551,421

(22) Filed: Aug. 31, 2009

(51) Int. Cl. G06F 17/00; G06F 17/30; G06F 9/54

(52) U.S. Cl. 707/770; 715/234; 719/328; 707/E17.014

(57) ABSTRACT

Systems and methods for gleaning insight by examining search queries and the query results are described. Interception logic may be provided in the API (application programming resource), across all of a hosts' resources to collect information about searches and the results being returned. This information can be aggregated in a service, which can be hit before other searches are run to determine if there is a better set of data that should be returned than the default response. Systems and methods for delivering a web page (e.g., search results) to a user in response to a page request (e.g., a request for search results) are also described, wherein the web page delivered to the user may be the same as or different from the page requested. The collected information is used to determine which page should be delivered to the user.

### BACKGROUND

1. Field

The subject invention relates to systems and methods for delivering a web page to a user in response to a page request, wherein the web page delivered to the user may be the same as or different from the page requested.

2. Related Art

Search web sites, such as google.com, allow Internet users to quickly locate information on the Internet. These search web sites crawl the web to index the content of web pages on the Internet so that they can be searched by users. Users can then enter search queries to identify relevant web pages, which can be selected by the user. When the user selects a web page, the user is linked to that web page and can then browse that web page. These sites, however, are unable to track the user.

Some sites (e.g., host sites) have internal search functions. For example, a user on CBS Interactive's download.com site may search for “Sony Laptop” (e.g., http://www.download.com/1770-20_{—}4-0.html?query=Sony+Laptop &tag=srch&searchtype=downloads). Search results from the download.com site that include “Sony Laptop” are returned to the user. The results for this search, however, are not likely relevant because there are very few software applications available on download.com that include the words “Sony” or “Laptop”. The user is more likely looking for search results from the CBS Interactive review site (e.g., http://reviews.cnet.com/1770-5_{—}7-0.html?query=Sony+Laptops&tag=srch) that includes reviews of Sony Laptops.

Furthermore, both the search sites and the host web sites try to improve the search results that are provided to the user by profiling the user. However, profiling the user requires both accurately identifying the user and significant processing resources. Many of these web sites require the user to log-in to the web site and perform significant off-line analysis of the user's behavior on the website (i.e., analysis of the user behavior after the user has left the web site).

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a method is provided that includes receiving a page request from a user, the page request specifying a specific page; querying an API coupled to plural data sources to ascertain available content relevant to the page request; accessing a data request profile associated with the page request; selecting content from the available content relevant to the page request based on information in the data request profile; generating a response to the page request using the selected content; and delivering the response to the user.

The data request profile may be based on a collection of data request insight data.

The data request insight data may include a query, a result provided in response to the query, and a user's session data following the query.

The collection of data request insight data may be aggregated from a plurality of requests associated with the data request.

The data request profile may include rules that identify content to select to deliver to the user based on the data request.

The page request may also include user data and the content may be selected based on the user data and the data request profile.

The insight data may include search queries and search results corresponding to the search queries.

According to another aspect of the invention, a computer-readable storage media having computer executable instructions stored thereon which cause a computer system to carry out a method when executed is provided, the method including receiving a page request from a user, the page request specifying a specific page; querying an API coupled to plural data sources to ascertain available content relevant to the page request; accessing a data request profile associated with the page request; selecting content from the available content relevant to the page request based on information in the data request profile; generating a response to the page request using the selected content; and delivering the response to the user.

The data request profile may be based on a collection of data request insight data.

The data request insight data may include a query, a result provided in response to the query, and a user's session data following the query.

The collection of data request insight data may be aggregated from a plurality of requests associated with the data request.

According to another aspect of the invention, a computer system is provided that includes a web server; a plurality of data stores; and an application programming interface in communication with the web server and the plurality of data stores, the application programming interface comprising insight data and logic configured to receive a search query and identify search results associated with the plurality of data stores using the insight data.

The insight data may include search queries and search results corresponding to the search queries.

The application programming interface may further include an interceptor that is configured to collect and store the insight data.

The application programming interface may further include an access point, the access point configured to receive the search query from the web server and deliver the search query to the logic.

According to an aspect of the invention, a method is provided that includes receiving a search query at one of a plurality of interconnected web sites; querying an application programming interface (API) coupled to plural data sources to ascertain search results responsive to the search query; collecting insight data, the insight data being an association of the search query with the search results; and storing the insight data.

The method may also include generating a data request profile based on the insight data.

The method may also include processing a request rule at an interceptor of the API, the request rule including pointers to request attributes that signal storage of the insight data.

According to another aspect of the invention, a computer-readable storage media having computer executable instructions stored thereon which cause a computer system to carry out a method when executed is provided, the method including receiving a search query at one of a plurality of interconnected web sites; querying an application programming interface (API) coupled to plural data sources to ascertain search results responsive to the search query; collecting insight data, the insight data being an association of the search query with the search results; and storing the insight data.

The method may also include generating a data request profile based on the insight data.

The method may also include processing a request rule at an interceptor of the API, the request rule including pointers to request attributes that signal storage of the insight data.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a network system according to one embodiment of the invention;

FIG. 2 is a block diagram of an exemplary system architecture;

FIG. 3 is a flow diagram for collecting data about page requests according to one embodiment of the invention;

FIG. 4 is a flow diagram for delivering a web page to a user according to one embodiment of the invention; and

FIG. 5 is a block diagram of an exemplary computer system according to one embodiment of the invention.

### DETAILED DESCRIPTION

Embodiments of the invention relate to systems and methods for gleaning insight by examining search queries and the query results. Interception logic may be provided in an API (application programming interface), across multiple resources or domains to collect information about searches and the results being returned. This information can be aggregated in a service, which can be hit before other searches are run to determine if there is a better set of data that should be returned than the default response.

Embodiments of the invention also relate to systems and methods for delivering a web page to a user in response to a page request, wherein the web page delivered to the user may be the same as or different from the page requested. When a user selects a page, such as a selection of a page from search results, the response is determined using available content related to the page, a data request profile and request data (e.g., user data in the request, header/referrer data in the request, etc.). In other words, the web site determines the page to deliver to the user based on the profile data even though the user requested a particular page. This improves responses to page requests coming from sources such as search results by leveraging knowledge of the data request and, optionally, the user's activities and the activities of other users who entered a similar page request.

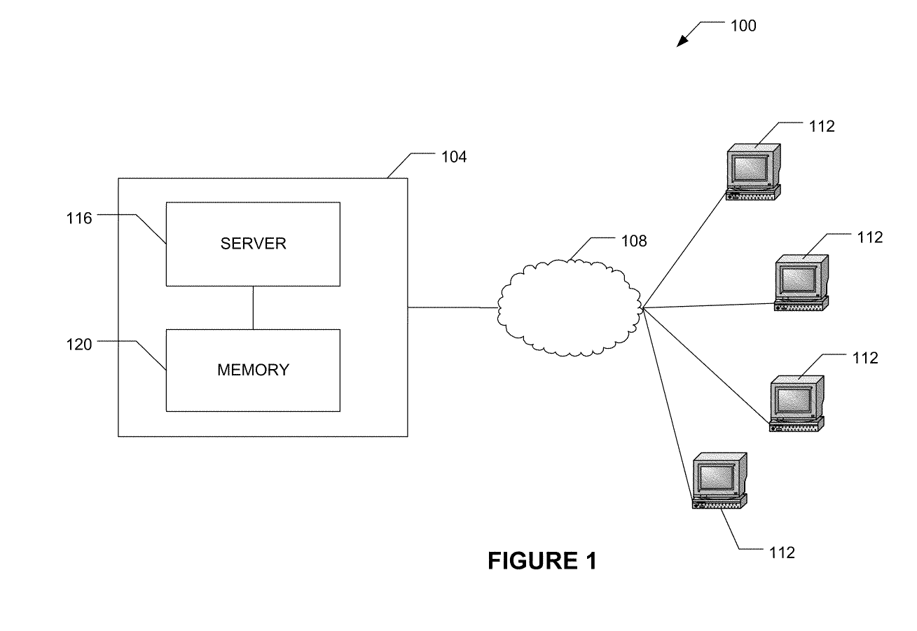

An embodiment of the invention will now be described in detail with reference to FIG. 1. FIG. 1 illustrates a web-based system 100 for tracking files on a user's computer and synchronizing user credentials at a web application and a user computer. The system 100 includes a tracking system 104 and a plurality of user systems 112 coupled via a network 108. The system 104 includes a server 116 and memory 120.

The tracking system 104 is connected to the plurality of user systems 112 over the network 108. The server 116 is in communication with the memory 120. The system 104 is typically a computer system, and may be an HTTP (Hypertext Transfer Protocol) server (e.g., an Apache server). The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof. The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view search results responsive to a search query, a request is communicated to the system 104 over the network 108. For example, a signal is transmitted from one of the user systems 112, the signal having a destination address (e.g., address representing the search results page for the web site), a request (e.g., a request to view the search results responsive to the search query) and a return address (e.g., address representing user system that initiated the request). The request may include a cookie that includes data identifying the user and/or the user computer. The server 116 accesses the database 120 to provide the user with a web page that includes the search results, which is communicated to the user over the network 108. For example, another signal may be transmitted that includes a destination address corresponding to the return address of the client system, and a web page responsive to the request.

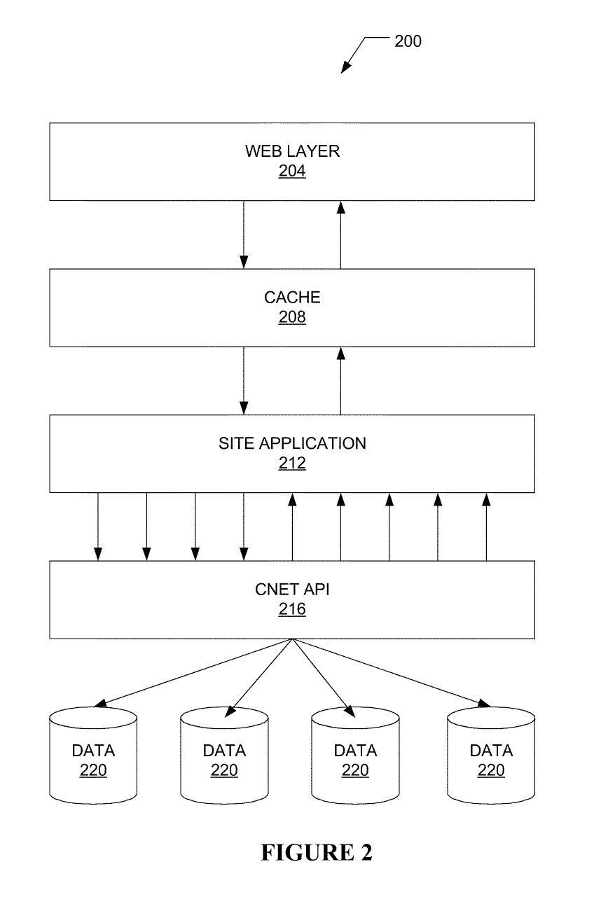

FIG. 2 illustrates an exemplary system architecture 200 at the server 104 according to one embodiment of the invention. It will be appreciated that the system architecture may be implemented as one server (e.g., server 104) or a plurality of servers in communication with one another

As shown in FIG. 2, the system architecture 200 includes a web layer 204, a cache 208, a site application 212, a site API (application programming interface) 216 and a plurality of data stores 220. It will be appreciated that the system architecture may vary from the illustrated architecture. For example, the web layer 204 may directly access the API 216 which accesses data stores 220, the system architecture 200 may not include the cache 208, etc., as will be appreciated by those skilled in the art. The web layer 204 is configured to receive user requests to access content through a web browser and return content that is responsive to the user request. The web layer 204 communicates the user requests to the cache 208.

The cache 208 is configured to temporarily store content that is accessed frequently by the web layer 204 and can be rapidly accessed by the web layer 204. In one embodiment, the cache 208 may be a caching proxy server. The cache 208 communicates the user requests to the site application 212.

The site application 212 is configured to update the cache 208 and to process user requests received from the web layer 204. The site application 212 may identify that the user request is for a page that includes data from multiple sources. The site application 212 can then convert the page request into a request for content from multiple sources and transmits these requests to the site API 216.

The site API 216 is configured to simultaneously access data from the plurality of data stores 220 to collect the data responsive to the plurality of requests from the site application 212. The plurality of data stores 220 include data about different sites owned by a company (e.g., download.com, cnet.com, tv.com, etc. owned by CBS Interactive).

The data in the data stores 220 is provided to the site API 216, which provides the content to the site application 212. The site application 212 updates the cache 208 and delivers the cached content in combination with the accessed content to the web layer 204, which delivers browsable content to the user.

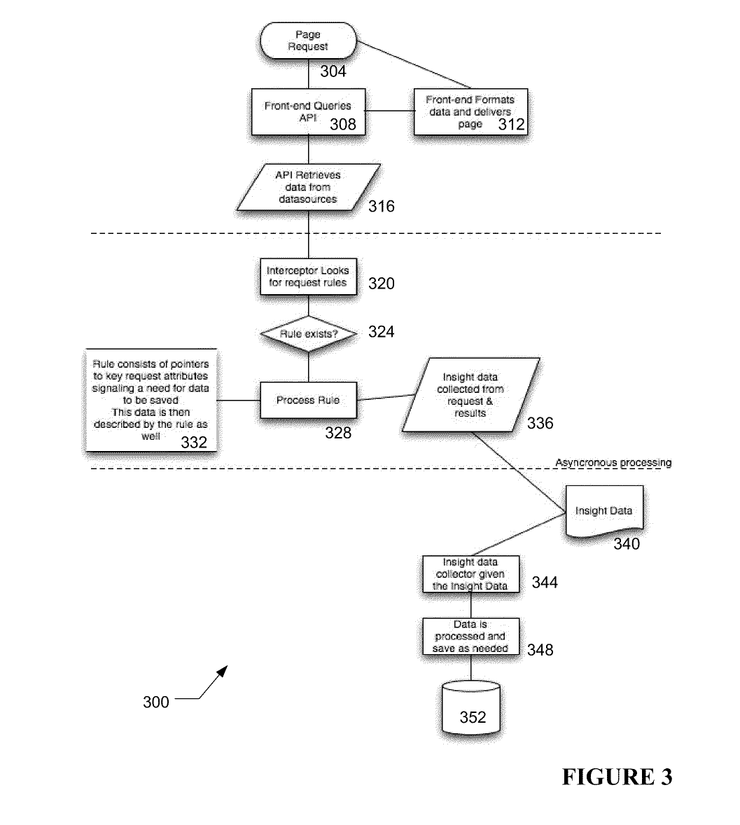

FIG. 3 illustrates a process for collecting data that can be used to target web pages based on the page request 300. It will be appreciated that the process 300 described below is merely exemplary and may include a fewer or greater number of steps, and that the order of at least some of the steps may vary from that described below.

The process 300 begins by receiving a page request (block 304). For example, the web layer 204 may receive a search query for “Sony Laptop”. The process 300 continues with the front-end querying the API (block 308). For example, the web layer 204 may query the API 216 for the search results that are responsive to the “Sony Laptop” search query. The process 300 continues by the API retrieving data from data sources (block 312). For example, the search results from the data stores 220 may be provided to the API 216. The process 300 continues by formatting the data and delivering a page in response to the page request (block 316). The API 216 or the site application 212 may format the data from the data stores 220 and deliver the page to the web layer 204, which delivers the page to the user.

The process 300 continues by an interceptor looking for request rules (block 320). For example, the API 216 may include an interceptor that identifies whether the request is a request for search results that is responsive to a search query. The interceptor determines whether rules exist (block 324). If yes, the process continues by processing the rule (block 328). The rule includes pointers to key request attributes that signal a need for data to be saved, which can then be described by the rule 332. The process 300 continues by collecting insight data from the request and the results (block 336). The process 300 continues by giving the insight data 340 to an insight data collector 344, which processes and saves the data in an insight data store 348 (block 352). For example, the interceptor at the API 216 may receive the search query for “Sony Laptop” from the download.com site. The API 216 accesses the search results from the data store 220 associated with the download.com site and stores the “Sony Laptop” search query and the associated search results from the download.com site in the insight data store 348. The interceptor at the API 216 may also receive the search query for “Sony Laptop” from the cnet.com review site. The API 216 accesses the search results from the data store 220 associated with the cnet.com site and stores the “Sony Laptop” search query and the associated search results from the cnet.com review site in the insight data store 348. It will be appreciated that the collection of insight data 340 can then be used to make determinations about future search queries for “Sony Laptop”. It will be appreciated that the insight data store 348 may also include information about the user's interaction with the search results or the user's behaviors before or after receiving the search results.

In one embodiment, an API access point may be built into the system architecture 200. The API access point may be queried before the search results are retrieved from the data store associated with the site that received the search query. The API access point can determine that the search results from the cnet.com review site should be returned when a search query for “Sony Laptops” is received at the download.com site.

Another exemplary query that may come into the system on multiple API end-points is “ipod”. Each of those end points returns a different result, but one of the end points may return more results than the other end points. In this example, the end points that has more results may rank higher in the API results and is likely a better match for queries.

Another exemplary query that may come into the system on multiple API end-points is “batteries”. Each end-point may return a similar amounts of results, but one end-pint may return a higher relevancy factor. The end point with the higher “relevancy” may rank higher in the API results and is likely a better match for queries.

In another example, a user may enter a search query for “MacAfee Antivirus” at google.com. The search results could include a page in CNET.COM directed to a news article about MacAfee announcing quarterly earnings. CNET.COM may also have a page including a review of MacAfee software and a page for downloading the MacAfee software. The user data might indicate that this specific user is not interested in financial data and that he already has downloaded the latest version of MacAfee on his computer, and the data request profile may indicate that users who are not interested in financial data and that have already downloaded the latest version of MacAfee should be directed to the review site. Therefore, the response to the page request could be the review page, even though the page request was for the news article.

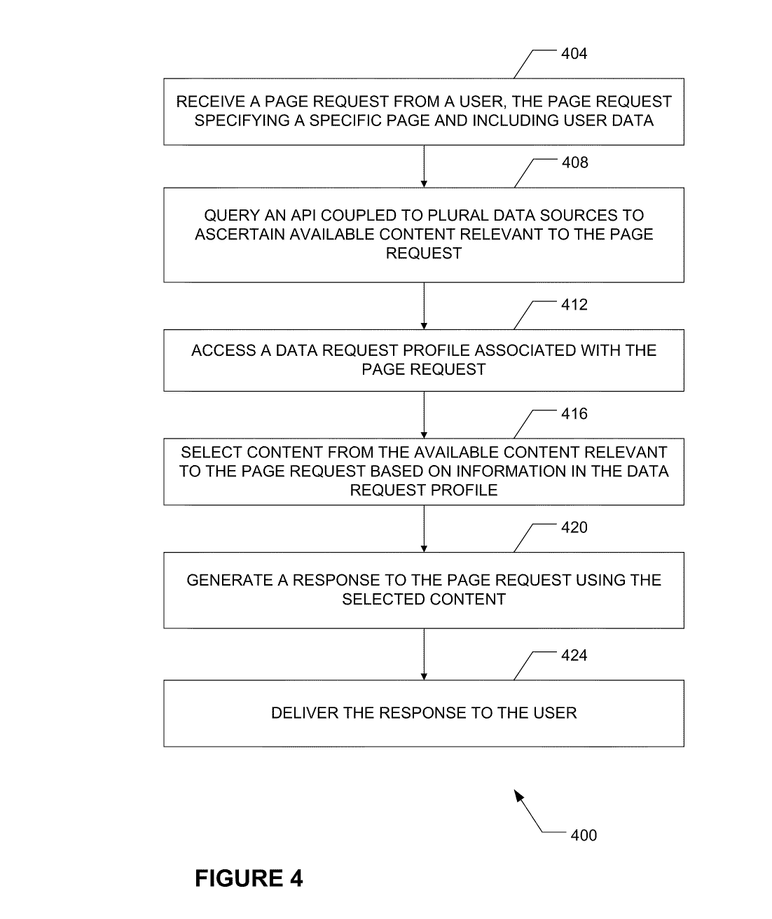

FIG. 4 illustrates a process 400 for delivering a page in response to a page request. It will be appreciated that the process 400 described below is merely exemplary and may include a fewer or greater number of steps, and that the order of at least some of the steps may vary from that described below.

As shown in FIG. 4, the process 400 begins by receiving a page request from a user, the page request specifying a specific page and including user data (block 404). The process 400 continues by querying an API coupled to plural data sources to ascertain available content relevant to the page request (block 408). For example, the web layer 204 may receive a search query for “Sony Laptop” and queries the API 216 which is coupled to the data sources 220.

The process 400 continues by accessing a data request profile associated with the page request (block 412). The data request profile may be based on an aggregation of the insight data. For example, a data request profile may be directed to a profile of data requests for the search query “Sony Laptop”. As described above, the insight data may include, for example, search queries that originated from download.com or the cnet.com review sites and their corresponding search results. An analysis of this insight data may indicate that the search results from the cnet.com review sites are more relevant to the search query “Sony Laptop” (e.g., because of the number of search results, the relevancy of the search results, etc.). In this case, the data request profile for “Sony Laptop” may return search results from only the cnet.com site (i.e., content from the data store 220 associated with the cnet.com site) or may rank content from the cnet.com site higher than content from the download.com site (i.e., content from the data store 220 associated with the download.com site).

The process 400 continues by selecting content from the available content relevant to the page request based on information in the data request profile (block 416). For example, the API 216 may select content from the data store 220 associated with the cnet.com site. It will be appreciated that the content may be selected based on both the data request profile and user data. For example, if the user data indicates that the user owns a particular “Sony Laptop” model, the content pulled may be accessories for that “Sony Laptop” model or new or upgraded “Sony Laptop” models from the cnet.com site.

The process 400 continues by generating a response to the page request using the selected content (block 420)and delivering the response to the user (block 424). For example, a web page that includes search results corresponding to the “Sony Laptop” from the cnet.com site may be delivered to the user.

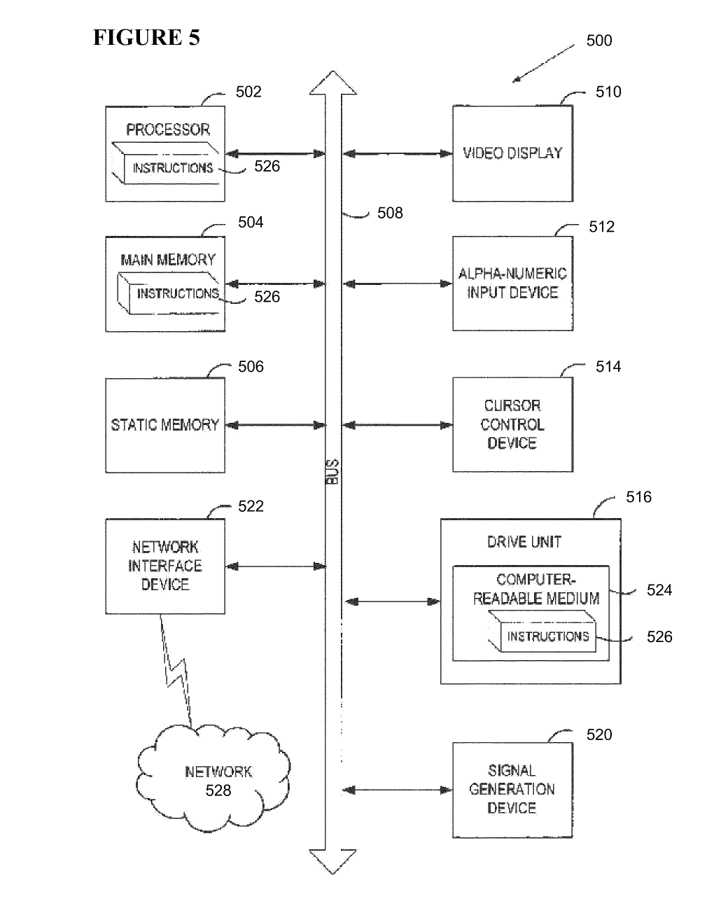

FIG. 5 shows a diagrammatic representation of machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU), a graphics processing unit (GPU) or both), a main memory 504 (e.g., read only memory (ROM), flash memory, dynamic random access memory (DRAM) such as synchronous DRAM (SDRAM) or Rambus DRAM (RDRAM), etc.) and a static memory 506 (e.g., flash memory, static random access memory (SRAM), etc.), which communicate with each other via a bus 508.

The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 520 (e.g., a speaker) and a network interface device 522.

The disk drive unit 516 includes a computer-readable medium 524 on which is stored one or more sets of instructions (e.g., software 526) embodying any one or more of the methodologies or functions described herein. The software 526 may also reside, completely or at least partially, within the main memory 504 and/or within the processor 502 during execution thereof by the computer system 500, the main memory 504 and the processor 502 also constituting computer-readable media. The software 526 may further be transmitted or received over a network 528 via the network interface device 522.

While the computer-readable medium 524 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method comprising:
receiving a page request from a user, the page request specifying a specific page;
querying an API coupled to plural data sources to ascertain available content relevant to the page request;
accessing a data request profile associated with the page request;
selecting content from the available content relevant to the page request based on information in the data request profile;
generating a response to the page request using the selected content; and
delivering the response to the user.

2. The computer-implemented method of claim 1, wherein the data request profile is based on a collection of data request insight data.

3. The computer-implemented method of claim 2, wherein the data request insight data comprises a query, a result provided in response to the query, and a user's session data following the query.

4. The computer-implemented method of claim 2, wherein the collection of data request insight data is aggregated from a plurality of requests associated with the data request.

5. The computer-implemented method of claim 1, wherein the data request profile comprises rules that identify content to select to deliver to the user based on the data request.

6. The computer-implemented method of claim 1, wherein the page request further includes user data and wherein the content is selected based on the user data and the data request profile.

7. The computer-implemented method of claim 1, wherein the insight data comprises search queries and search results corresponding to the search queries.

8. A computer-readable storage media having computer executable instructions stored thereon which cause a computer system to carry out a method when executed, the method comprising:
receiving a page request from a user, the page request specifying a specific page;
querying an API coupled to plural data sources to ascertain available content relevant to the page request;
accessing a data request profile associated with the page request;
selecting content from the available content relevant to the page request based on information in the data request profile;
generating a response to the page request using the selected content; and
delivering the response to the user.

9. The computer-readable storage media of claim 8, wherein the data request profile is based on a collection of data request insight data.

10. The computer-readable storage media of claim 8, wherein the data request insight data comprises a query, a result provided in response to the query, and a user's session data following the query.

11. The computer-readable storage media of claim 8, wherein the collection of data request insight data is aggregated from a plurality of requests associated with the data request.

12. A computer system comprising:
a web server;
a plurality of data stores; and
an application programming interface in communication with the web server and the plurality of data stores, the application programming interface comprising insight data and logic configured to receive a search query and identify search results associated with the plurality of data stores using the insight data.

13. The computer system of claim 12, wherein the insight data comprises search queries and search results corresponding to the search queries.

14. The computer system of claim 12, wherein the application programming interface comprises an interceptor that is configured to collect and store the insight data.

15. The computer system of claim 12, wherein the application programming interface comprises an access point, the access point configured to receive the search query from the web server and deliver the search query to the logic.

16. A computer-implemented method comprising:
receiving a search query at one of a plurality of interconnected web sites;
querying an application programming interface (API) coupled to plural data sources to ascertain search results responsive to the search query;
collecting insight data, the insight data being an association of the search query with the search results; and
storing the insight data.

17. The computer-implemented method of claim 16, further comprising generating a data request profile based on the insight data.

18. The computer-implemented method of claim 16, further comprising processing a request rule at an interceptor of the API, the request rule including pointers to request attributes that signal storage of the insight data.

19. A computer-readable storage media having computer executable instructions stored thereon which cause a computer system to carry out a method when executed, the method comprising:
receiving a search query at one of a plurality of interconnected web sites;
querying an application programming interface (API) coupled to plural data sources to ascertain search results responsive to the search query;
collecting insight data, the insight data being an association of the search query with the search results; and
storing the insight data.

20. The computer-readable storage media of claim 19, further comprising generating a data request profile based on the insight data.

21. The computer-readable storage media of claim 19, further comprising processing a request rule at an interceptor of the API, the request rule including pointers to request attributes that signal storage of the insight data.
